(19) United States
(12) Patent Application Publication
(10) Pub. No.: US 2026/0022740 A1
(43) Pub. Date: Jan. 22, 2026

(54) UTV Rear Gear Drive Device

(71) Applicant: Richard Harrison, Chesapeake, VA (US)

(72) Inventor: Richard Harrison, Chesapeake, VA (US)

(21) Appl. No.: 19/260,737

(22) Filed: Jul. 7, 2025

Related U.S. Application Data
(60) Provisional application No. 63/671,801, filed on Jul. 16, 2024.

(51) Int. Cl. F16D 1/108; F16H 55/17

(52) U.S. Cl. CPC F16D 1/108; F16H 55/17; F16D 2300/10; F16D 2300/12

(57) ABSTRACT

A UTV rear gear drive device is provided. The device is configured to replace the original drive gear within the rear transmission assembly of a UTV. The device comprises a reinforced drive gear body incorporating a central axial opening with internal splines that are circumferentially distributed and dimensioned to engage a corresponding splined shaft. The internal spline engagement spans the full axial length of the gear, providing extended contact with a mating shaft to minimize fretting and enhance torsional stiffness. Exterior splines may be integrated into or formed on the outer surface of the gear body and are designed to interact with adjacent drivetrain elements such as countershaft or idler gears. A splined shaft is longitudinally inserted through the central opening and engages with the internal splines along the length of the shaft.

### CROSS REFERENCE TO RELATED APPLICATION

The present application claims priority to, and the benefit of, U.S. Provisional Application No. 63/671,801, which was filed on Jul. 16, 2024, and is incorporated herein by reference in its entirety.

### FIELD OF THE INVENTION

The present invention relates generally to the field of UTVs. More specifically, the present invention relates to a device designed to replace the original rear drive gear in a UTV transmission assembly with a reinforced gear featuring full-length internal spline engagement for improved torque transfer and reduced wear. Accordingly, the present disclosure makes specific reference thereto. Nonetheless, it is to be appreciated that aspects of the present invention are also equally applicable to other like applications, devices, and methods of manufacture.

### BACKGROUND

In the domain of utility terrain vehicles (UTVs), a persistent issue involves structural failure within the rear drivetrain system, specifically at the interface where the half shaft inserts into the rear drive gear. This failure frequently manifests as stripping of the gear teeth or loss of spline integrity, which can result in compromised wheel drive functionality. In some cases, only one side of the drivetrain is affected, leading to vehicle pull or handling inconsistencies. In more severe cases, both sides may lose power transmission, rendering the UTV immobile. Such failures typically occur under high torque loads, frequent shock loading, or during rapid acceleration and deceleration events encountered in off-road environments. The repetitive nature of this failure mode places a burden on vehicle operators and fleet managers, both in terms of downtime and maintenance costs. Standard drive gear components often lack the mechanical robustness required for these high-load and high-cycle conditions. As UTVs are increasingly used in demanding commercial, recreational, and agricultural settings, the reliability of drivetrain components becomes critical.

Therefore, there exists a long-felt need in the art for a UTV rear gear drive device that prevents spline stripping at the half shaft insertion point. There also exists a long-felt need in the art for a UTV rear gear drive device that improves drivetrain longevity and reduces the frequency of maintenance. Moreover, there exists a long-felt need in the art for a UTV rear gear drive device that ensures consistent torque transmission under high-load and high-vibration operating conditions.

The subject matter disclosed and claimed herein, in one embodiment thereof, comprises a UTV rear gear drive device. The device is configured to replace the original drive gear within the rear transmission assembly of a UTV. The device comprises a reinforced drive gear body incorporating a central axial opening with internal splines that are circumferentially distributed and dimensioned to engage a corresponding splined shaft. The internal spline engagement spans the full axial length of the gear, providing extended contact with a mating shaft to minimize fretting and enhance torsional stiffness. Exterior splines may be integrated into or formed on the outer surface of the gear body and are designed to interact with adjacent drivetrain elements such as countershaft or idler gears. A splined shaft is longitudinally inserted through the central opening and engages with the internal splines along the length of the shaft. Axial retention of the drive gear and associated components is achieved by opposing locknuts and axle end caps mounted at each end of the shaft. The axle end caps include threaded holes for secure mechanical fastening to half shafts.

In this manner, the UTV rear gear drive device of the present invention accomplishes all the foregoing objectives and provides a device that addresses the primary failure mode of rear drive gear spline stripping on UTVs through the implementation of full-length spline engagement and reinforced materials. The device further enhances drivetrain longevity and reduces maintenance requirements through high-strength construction and optimized fit between mating components. Furthermore, the spline interface and secure axial retention mechanisms provide consistent torque transfer under dynamic operating loads, thereby improving overall UTV reliability. The compatibility with diverse drivetrain configurations also enables flexible application across different UTV platforms.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a UTV rear gear drive device. The device addresses structural failure issues in the rear drive gear of utility terrain vehicles and similar machinery by incorporating multiple reinforcements aimed at improving mechanical strength, durability, and reliability, thereby reducing maintenance frequency and extending drivetrain service life.

The device is comprised of a reinforced drive gear that serves as a direct replacement for a factory-installed gear within the rear transmission assembly. The drive gear includes a gear body with a central axial opening featuring internal splines circumferentially distributed and dimensioned for engagement with a mating splined shaft. The drive gear also includes exterior splines formed around an outer surface, matching the internal spline considerations in both profile and manufacturing technique, wherein the exterior splines enable proper engagement with other drivetrain components such as countershaft gears and idler gears.

A splined shaft is longitudinally inserted through the central opening of the drive gear and has external splines for full-length engagement with the internal splines. This engagement enhances torsional rigidity, minimizes fretting wear, and supports high torque loads. Spline flanks may be surface treated to resist wear and extend component lifespan.

At both ends of the splined shaft are axle end caps comprising threaded holes to receive fasteners for securing corresponding half shafts. The axle end caps may be cylindrical, hexagonal, or flanged, selected based on torque and assembly requirements. The drive gear and axle end caps are axially retained on the shaft by a pair of locknuts, which may include anti-loosening features such as nylon inserts or thread lockers.

Accordingly, the UTV rear gear drive device of the present invention is particularly advantageous as it provides a device that addresses the primary failure mode of rear drive gear spline stripping on UTVs through the implementation of full-length spline engagement and reinforced materials. The device further enhances drivetrain longevity and reduces maintenance requirements through high-strength construction and optimized fit between mating components. Furthermore, the spline interface and secure axial retention mechanisms provide consistent torque transfer under dynamic operating loads, thereby improving overall UTV reliability. The compatibility with diverse drivetrain configurations also enables flexible application across different UTV platforms. In this manner, the UTV rear gear drive device overcomes the limitations of existing UTV rear drive trains known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective exploded view of one potential embodiment of a UTV rear gear drive device of the present invention in accordance with the disclosed architecture;

FIG. 2 illustrates a side view of a shaft and a drive gear of one potential embodiment of a UTV rear gear drive device of the present invention in accordance with the disclosed architecture;

FIG. 3 illustrates a front exploded view of a shaft and end caps of one potential embodiment of a UTV rear gear drive device of the present invention in accordance with the disclosed architecture; and

FIG. 4 illustrates a perspective view of one potential embodiment of a UTV rear gear drive device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a UTV rear gear drive device that prevents spline stripping at the half shaft insertion point. There also exists a long-felt need in the art for a UTV rear gear drive device that improves drivetrain longevity and reduces the frequency of maintenance. Moreover, there exists a long-felt need in the art for a UTV rear gear drive device that ensures consistent torque transmission under high-load and high-vibration operating conditions.

The present invention, in one exemplary embodiment, is comprised of a UTV rear gear drive device. The device is comprised of a reinforced drive gear designed to directly replace a factory-installed gear within the rear transmission assembly. The gear body features a central axial opening with circumferentially distributed internal splines dimensioned to engage with a mating splined shaft. Additionally, exterior splines are formed around the outer surface of the gear body, corresponding to the internal spline profiles and manufacturing methods, to enable proper meshing with drivetrain components such as countershaft and idler gears.

A splined shaft is inserted longitudinally through the central axial opening, with external splines configured to achieve full-length engagement with the internal splines of the drive gear. This configuration provides increased torsional rigidity, minimizes fretting wear, and accommodates high torque transmission. Surface treatments may be applied to the spline flanks to resist wear and prolong operational life.

Positioned at each end of the splined shaft are axle end caps that include threaded holes for fastening corresponding half shafts. These end caps may be cylindrical, hexagonal, or flanged, depending on torque transmission and assembly needs. Axial retention of both the drive gear and axle end caps is achieved by a pair of locknuts mounted on threaded ends of the shaft, with anti-loosening features such as nylon inserts or thread lockers.

As a result, the UTV rear gear drive device offers a substantial improvement over existing solutions by mitigating rear drive gear spline stripping through the implementation of full-length spline engagement and high-strength material construction. The device enhances drivetrain durability and decreases maintenance demands via an optimized fit between mating components. The robust spline interface and secure axial retention mechanisms ensure reliable torque transfer under dynamic conditions, thus increasing overall reliability. Its compatibility with a wide range of drivetrain architectures supports flexible deployment across various UTV platforms, effectively addressing limitations present in existing UTV rear drivetrains.

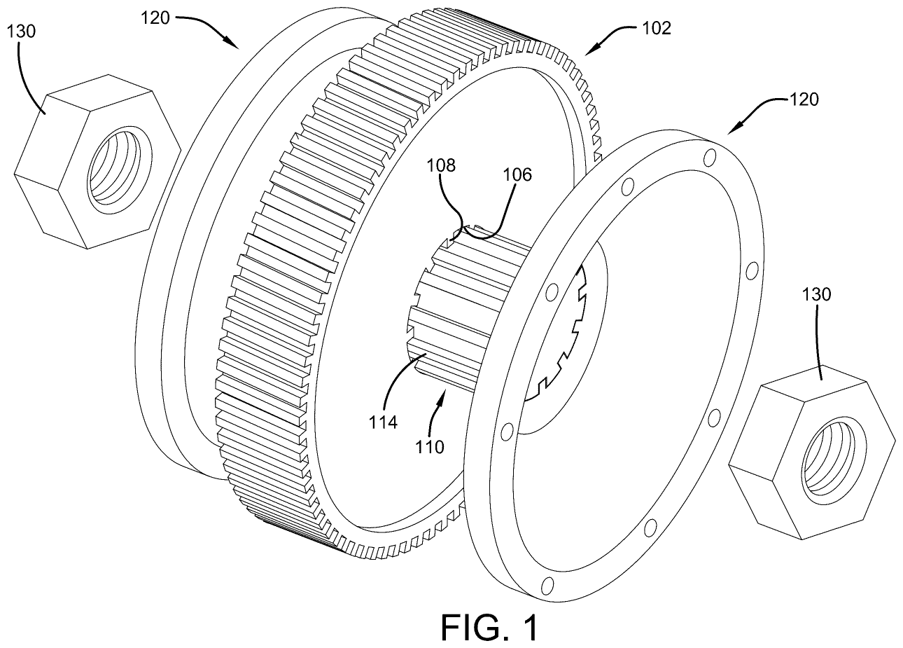

Referring initially to the drawings, FIG. 1 illustrates a perspective exploded view of one potential embodiment of a UTV rear gear drive device 100 of the present invention in accordance with the disclosed architecture. The device 100 is designed to address drive shaft integrity issues in utility terrain vehicles (UTVs) and similar machinery, particularly in applications where the rear drive gear commonly experiences structural failure at the point of half shaft insertion. To mitigate this issue, the device 100 is comprised of multiple structural enhancements that may collectively improve mechanical strength, operational durability, and component reliability. These structural reinforcements may significantly reduce the incidence of drive gear failure, prolong the effective service life of the drivetrain components, and lower the frequency of required maintenance interventions.

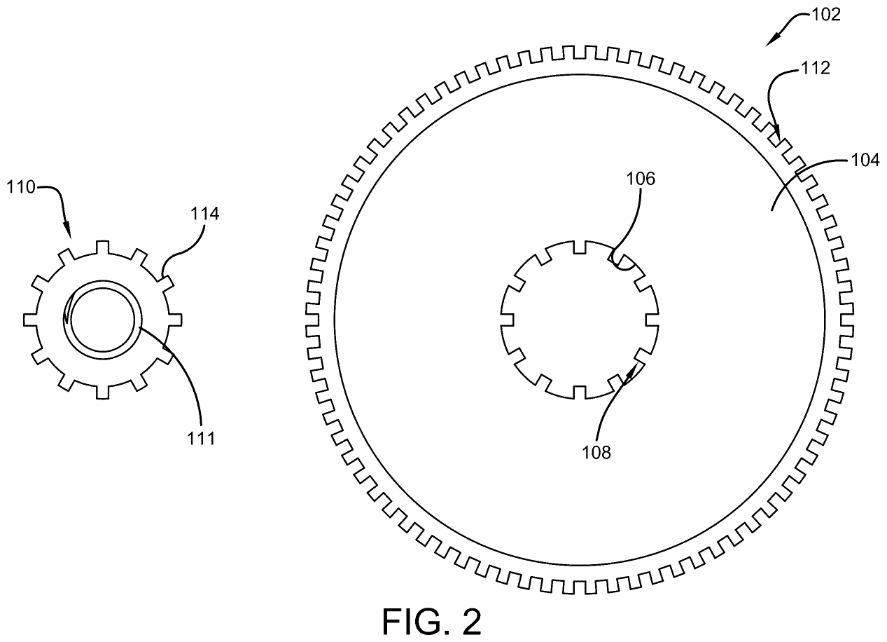

The device 100 is comprised of a reinforced drive gear 102 configured to function as a direct replacement for a factory-installed drive gear located within the rear transmission assembly of a UTV or similar drivetrain architecture. The drive gear 102 may be comprised of a gear body 104 featuring a central axial opening 106 that extends entirely along the longitudinal axis of the gear 102, as seen in FIG. 1 and FIG. 2. The central axial opening 106 may be comprised of a plurality of internal splines 108 which are preferably circumferentially distributed and dimensioned to engage with a mating splined shaft 110, as seen in FIG. 1.

The internal splines 108 may be formed using machining processes such as broaching, hobbing, or wire EDM to achieve the necessary geometric tolerances and surface finish requirements necessary for high-load transmission. In certain embodiments, the internal splines 108 may be straight cut, helical, or involute in profile. Straight cut splines may offer ease of manufacturing and direct load transfer, whereas helical splines may improve load distribution and reduce noise during operation. Involute splines may be selected for applications requiring self-centering characteristics and improved alignment under load.

The spline 108 profile, pressure angle, tooth depth, and root radius may be optimized for specific torque and fatigue life requirements. The fit between the internal splines 108 and the mating shaft 110 may be classified as interference, transition, or clearance, depending on the assembly method and expected service conditions. An interference fit may be employed in high-torque applications to eliminate backlash and enhance torsional rigidity, while a transition fit may balance ease of assembly with torque capacity. The inner bore diameter and spline 108 count of the central axial opening 106 may vary based on torque transmission capacity and compatibility with a range of shaft 110 diameters and spline 108 configurations.

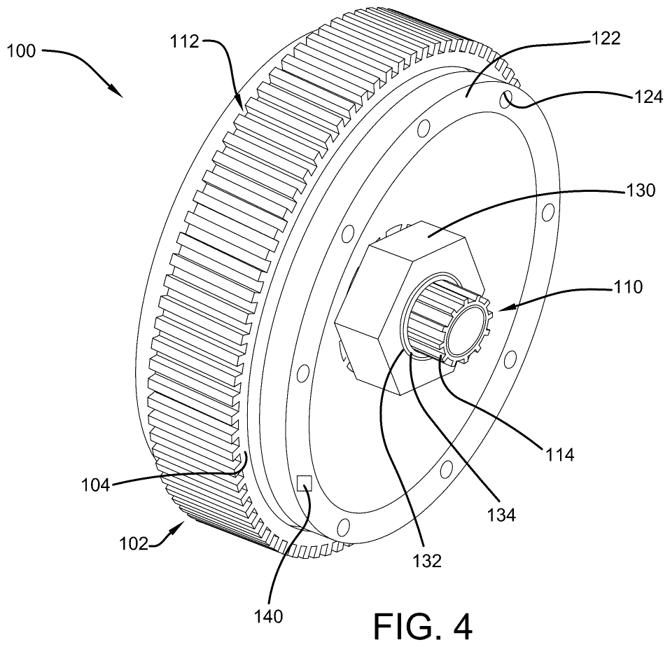

The drive gear 102 may further be comprised of exterior splines 112 formed circumferentially around the outer surface of the gear body 104, as seen in FIG. 2 and FIG. 4. The exterior splines 112 may mirror the internal spline 108 considerations in terms of profile and manufacturing method. In some cases, exterior splines 112 may be formed integrally with the gear body 104 or added via a secondary process such as spline rolling or spline cutting. The spline count and pitch diameter of the exterior splines 112 may be selected to ensure proper meshing with existing mating drivetrain elements such as but not limited to countershaft gears, idler gears, or output gears.

A splined shaft 110 may be longitudinally inserted through the central axial opening 106 of the drive gear 102, as seen in FIG. 1 and FIG. 4. The splined shaft 110 may be comprised of external splines 114 dimensioned to correspond and mate with the internal splines 108 of the drive gear 102, allowing full-length spline 108,114 engagement across the axial span of the central opening 106. The length of spline 108,114 engagement may be calculated to exceed the minimum engagement length required for the transmitted torque, based on material yield strength, contact pressure, and expected duty cycle. Full-length engagement may reduce micro-movements under load, minimize fretting wear, and enhance long-term reliability under cyclical loading conditions. In high-load configurations, the spline 108,114 flanks may be surface hardened or coated to resist galling and pitting, extending the operational lifespan of the mating components. This full-length engagement may serve to enhance torsional rigidity and minimize localized shear stress concentrations, especially under high torque loading scenarios such as rapid acceleration or off-road terrain impact.

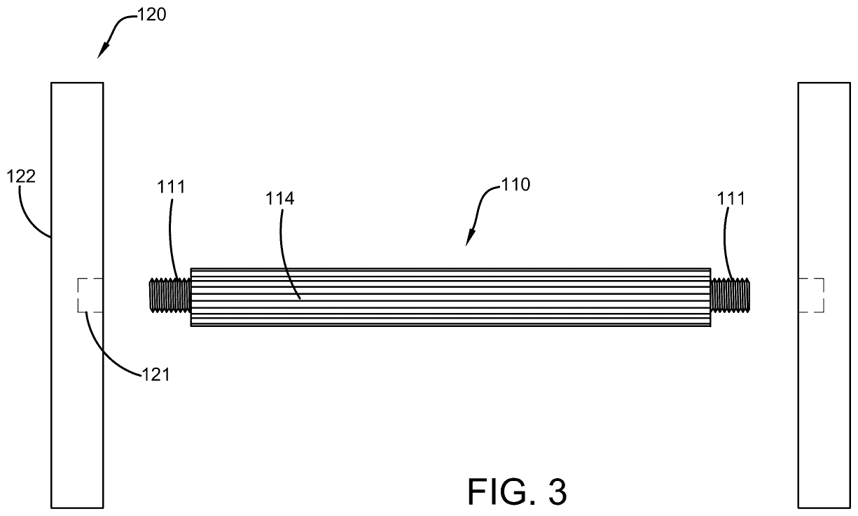

Axially mounted at opposing ends of the splined shaft 110 may be a pair of axle end caps 120, wherein each axle end cap 120 may be comprised of a cap body 122 featuring a series of threaded holes 124 (as seen in FIG. 4) configured to receive mechanical fasteners used for securing a corresponding half shaft of the UTV to the respective end cap 120. Depending on performance requirements and installation constraints, the axle end caps 120 may be shaped as cylindrical, hexagonal, or flanged components to enhance torque transmission fidelity or facilitate tool engagement during assembly. The end caps 120 may be comprised of a threaded opening 121 (as seen in FIG. 3) that receives at least one threaded end 111 of the shaft 110.

The drive gear 102 and the axle end caps 120 may be axially retained along the splined shaft 110 by a pair of locknuts 130, which may be threaded onto opposing threaded ends of the shaft 110, as seen in FIG. 4. The locknuts 130 may feature anti-loosening mechanisms 132 such as but not limited to nylon inserts, chemical thread lockers, or mechanically interlocking tabs. In alternative and/or additional embodiments, additional axial retention mechanisms 134 may be employed, such as snap rings, tab washers, or castellated nuts paired with cotter pins, to provide redundant restraint and prevent unintentional axial displacement during high-vibration or impact-intensive conditions.

The components of the device 100 may be manufactured from materials such as but not limited to heat-treated chromoly steel, nitrided alloy steels, forged aluminum, or high-strength hybrid composites. Surface treatments 140 may be applied to critical surfaces and engagement interfaces, including but not limited to black oxide coatings, zinc-nickel platings, diamond-like carbon (DLC) coatings, or phosphate conversion coatings, each selected to enhance corrosion resistance, minimize wear, and provide an improved surface finish.

The structural integration of a fully engaged splined interface between the shaft 110 and drive gear 102, combined with the bolted axle end cap 120 configuration, creates a drive connection architecture capable of withstanding the dynamic loads and operational stresses encountered in UTV environments while reducing the potential for drive system failure. Additionally, the modular compatibility of the design with varying gear and shaft specifications may enable broad adaptability across diverse vehicle models and drivetrain configurations.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “UTV rear gear drive device” and “device” are interchangeable and refer to the UTV rear gear drive device 100 of the present invention.

Notwithstanding the forgoing, the UTV rear gear drive device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the UTV rear gear drive device 100 as shown in the FIGS. are for illustrative purposes only, and that many other sizes and shapes of the UTV rear gear drive device 100 are well within the scope of the present disclosure. Although the dimensions of the UTV rear gear drive device 100 are important design parameters for user convenience, the UTV rear gear drive device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A UTV rear gear drive device comprising:
a drive gear comprising a gear body having a central axial opening extending along a longitudinal axis of the gear body, the central axial opening comprising a plurality of internal splines;
a splined shaft longitudinally inserted through the central axial opening of the drive gear, the splined shaft comprising a plurality of external splines; and
an axle end cap comprising a cap body and a threaded hole.

2. The UTV rear gear drive device of claim 1, wherein the plurality of internal splines are comprised of straight cut splines.

3. The UTV rear gear drive device of claim 1, wherein the drive gear is comprised of a surface treatment comprised of a black oxide coating, a zinc-nickel plating, a carbon coating, or a phosphate conversion coating.

4. The UTV rear gear drive device of claim 1, wherein the axle end cap is comprised of a cylindrical axle end cap.

5. The UTV rear gear drive device of claim 1, wherein the plurality of internal splines and the plurality of external splines engage in an interference fit.

6. The UTV rear gear drive device of claim 1 further comprised of a locknut.

7. A UTV rear gear drive device comprising:
a drive gear comprising a gear body having a plurality of exterior splines, and a central axial opening extending along a longitudinal axis of the gear body, the central axial opening comprising a plurality of internal splines;
a splined shaft longitudinally inserted through the central axial opening of the drive gear, the splined shaft comprising a plurality of external splines corresponding to the plurality of internal splines of the drive gear;
an axle end cap comprising a cap body and a threaded hole; and
a locknut.

8. The UTV rear gear drive device of claim 7, wherein the plurality of internal splines are comprised of helical cut splines.

9. The UTV rear gear drive device of claim 7, wherein the splined shaft is comprised of a surface treatment comprised of a black oxide coating, a zinc-nickel plating, a carbon coating, or a phosphate conversion coating.

10. The UTV rear gear drive device of claim 7, wherein the plurality of exterior splines are formed circumferentially around the gear body.

11. The UTV rear gear drive device of claim 7, wherein the axle end cap is comprised of a hexagonal axle end cap.

12. The UTV rear gear drive device of claim 7, wherein the plurality of internal splines and the plurality of external splines engage in a transition fit.

13. A UTV rear gear drive device comprising:
a drive gear comprising a gear body having a plurality of exterior splines, and a central axial opening extending along a longitudinal axis of the gear body, the central axial opening comprising a plurality of internal splines;
a splined shaft longitudinally inserted through the central axial opening of the drive gear, the splined shaft comprising a plurality of external splines corresponding to the plurality of internal splines of the drive gear;
an axle end cap comprising a cap body and a threaded hole; and
a locknut comprised of an anti-loosening mechanism.

14. The UTV rear gear drive device of claim 13, wherein the plurality of internal splines are comprised of involute splines.

15. The UTV rear gear drive device of claim 13, wherein the anti-loosening mechanism is comprised of a nylon insert.

16. The UTV rear gear drive device of claim 13, wherein the anti-loosening mechanism is comprised of a chemical thread locker.

17. The UTV rear gear drive device of claim 13, wherein the anti-loosening mechanism is comprised of a mechanically interlocking tab.

18. The UTV rear gear drive device of claim 13, wherein the axle end cap is comprised of a surface treatment comprised of a black oxide coating, a zinc-nickel plating, a carbon coating, or a phosphate conversion coating.

19. The UTV rear gear drive device of claim 13, wherein the axle end cap is comprised of a flanged axle end cap.

20. The UTV rear gear drive device of claim 13, wherein the plurality of internal splines and the plurality of external splines engage in a clearance fit.
